(19) United States
(12) Patent Application Publication
(10) Pub. No.: US 2009/0133045 A1
(43) Pub. Date: May 21, 2009

(54) Compact disk deck apparatus for vehicles

(75) Inventor: Sang Min Kim, Gunpo (KR)

Correspondence Address: Edwards Angell Palmer Dodge LLP, P.O. Box 55874, Boston, MA, 02205, US

(73) Assignee: Hyundai Motor Company, Seoul (KR)

(21) Appl. No.: 12/082,945

(22) Filed: Apr. 15, 2008

(30) Foreign Application Priority Data
Nov. 16, 2007 (KR) 10-2007-0117470

(51) Int. Cl. G11B 17/05

(52) U.S. Cl. 720/619

(57) ABSTRACT

A compact disk (CD) deck apparatus for vehicles comprises a CD deck body having a gate through which a CD is to be loaded and unloaded, and a guide unit provided on the gate to guide the loading and unloading of the CD. The guide unit includes a housing provided on the gate, a turning plate provided in the housing so as to be able to rotate in an unloading direction of the CD, and a guide piece protruding from the turning plate such that one CD is loaded into the gate.

### CROSS-REFERENCE TO RELATED APPLICATIONS

This application claims priority to Korean Application No. 10-2007-0117470, filed on Nov. 16, 2007, the disclosure of which is incorporated herein by reference.

### BACKGROUND

1. Technical Field

The present invention relates to a compact disk (CD) deck apparatus for vehicles.

2. Background Art

Vehicles are equipped with a CD player, which reproduces information recorded on a CD. Conventionally, the CD player includes a CD deck. The CD deck is provided with a CD gate through which a CD is inserted. One problem with the conventional CD deck apparatuses is that when two CDs are forcibly inserted through the CD gate, it is difficult to eject the CDs.

The information disclosed in this Background section is only for enhancement of understanding of the background of the invention and should not be taken as an acknowledgement or any form of suggestion that this information forms the prior art that is already known to a person skilled in the art.

### SUMMARY

Accordingly, the present invention has been made keeping in mind the above problems occurring in the prior art, and an object of the present invention is to provide a CD deck apparatus for vehicles which can prevent two CDs from being inserted into a CD deck body and allow a CD or CDs in the CD deck body to be smoothly ejected.

In order to achieve the above object, in one aspect, there is provided a CD deck apparatus for vehicles comprising a CD deck body having a gate through which the CD is to be loaded and unloaded. The gate is provided with a guide unit for guiding the loading and unloading of the CD. The guide unit includes: a housing provided on the gate; a turning plate provided in the housing so as to rotate in the direction in which the CD is unloaded; and a guide piece protruding from the turning plate such that one CD is loaded into the gate.

Preferably, the guide piece may have a vertical part disposed so as to face a loading direction of the CD, and an inclined part extending downward from an upper portion of the vertical part in the loading direction of the CD.

Preferably, an engaging rib may be fixedly provided in the housing to prevent the turning plate from rotating in the loading direction of the CD. The engaging rib may be connected with the turning plate by an elastic member.

One advantage according to the present invention is that two CDs are prevented from being loaded into the CD deck body and a single loaded CD can be smoothly reproduced.

Another advantage is that even if two CDs are forcefully loaded into the deck body, the CDs can be smoothly unloaded from the CD deck body, thereby improving the merchantability of a product.

### BRIEF DESCRIPTION OF THE DRAWINGS

The above and other features of the present invention will now be described in detail with reference to certain exemplary embodiments thereof illustrated the accompanying drawings which are given hereinbelow by way of illustration, and thus are not limitative of the present invention, and wherein:

FIG. 1 is a front view illustrating a CD deck apparatus for vehicles according to a preferred embodiment of the present invention;

FIG. 2 is a perspective view illustrating a guide unit of the CD deck apparatus according to a preferred embodiment of the present invention;

FIG. 3 is an exploded perspective view illustrating the guide unit of FIG. 2; and

FIG. 4 is a view illustrating the operation state of the guide unit of FIG. 2 when the CD is unloaded.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to a preferred embodiment of the present invention, an example of which is illustrated in the accompanying drawings and described below. While the invention will be described in conjunction with an exemplary embodiment, it should be understood that the description is not intended to limit the invention to the exemplary embodiment. On the contrary, the invention is intended to cover not only the exemplary embodiment, but also various alternatives, modifications, equivalents and other embodiments, which may be included within the spirit and scope of the invention as defined by the appended claims.

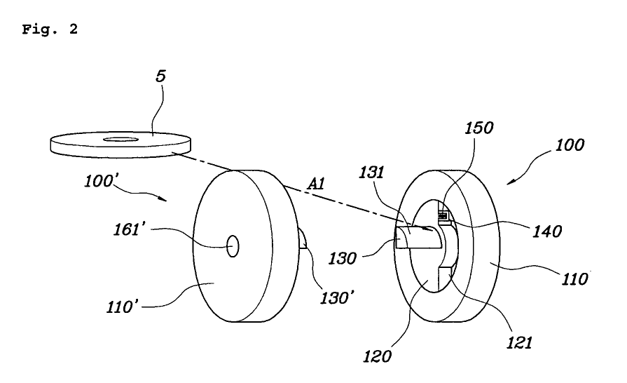

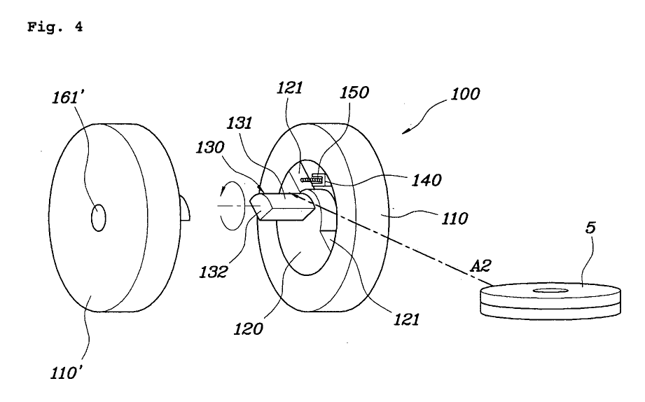

The moving direction denoted by an arrow A1 of a CD in FIG. 2 is defined as the direction in which the CD is loaded into a CD deck body, and that denoted by an arrow A2 in FIG. 4 is defined as the direction in which the CD is unloaded from the inside toward the outside of the CD deck body.

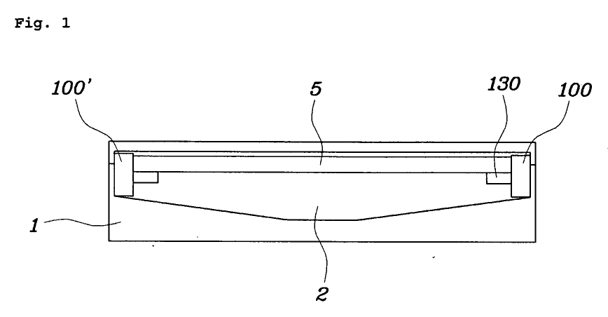

As shown in FIGS. 1 and 2, a pair of guide units 100 and 100′ are provided opposite each other on both side walls of a gate 2 of a CD deck body 1 so as to guide the loading and unloading of the CD 5. The guide units 100 and 100′ each include a housing 110, a turning plate 120, installed in the housing 110 so as to be able to rotate in the direction in which the CD 5 is unloaded, and guide pieces 130 protruding from the turning plate 120.

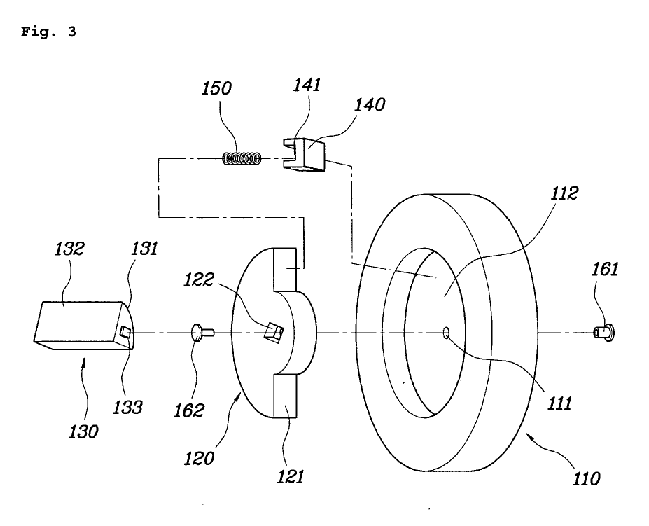

As shown in FIGS. 2 and 3, the housing 110 is fixed to a sidewall of the gate 2 to form a turning groove 112. In the turning groove 112, the turning plate 120 is rotatably installed, and an engaging rib 140 is fixedly provided so as to allow the turning plate 120 to rotate in only one direction.

The engaging rib 140 is provided with an engaging groove 141, which opens in one direction toward the turning plate 120. An elastic member 150 is fixed to the engaging groove 141 so as to be elastically connected with the turning plate 120. The elastic member 150 serves to return the turning plate, which is rotated in one direction, to its original position.

The housing 110 is connected with the turning plate 120 through a rotating axle, and has a through-hole 111 through which the rotating axle passes. The rotating axle consists of a first axle 161, which is inserted into the through-hole 111 through the turning plate 120 from one side of the housing 110, and a second axle 162, which is inserted into the through-hole 11 from the other side of the housing 110 so as to be coupled to the first axle 161.

The turning plate 120 is in the form of a semi-circular disc, to the center of which the rotating axle is coupled. The turning plate 120 is provided with a sidewall part 121 connected with the elastic member 150, and a fixing groove 122 into which the first axle 161 is coupled. A fixing piece 133 is inserted into the fixing groove 122 so as to fix the guide piece 130.

The guide piece 130 is fixed to the turning plate 120 to guide the movement of the CD 5. That is, one end of the guide piece 130 is fixed to the turning plate 120 through the fixing piece 133, and the other end of the guide piece 130 protrudes toward the center of the gate 2.

In detail, the guide piece 130 includes a vertical part 132 disposed so as to face the loading direction of the CD 5, and an inclined part 131 extending downward from an upper portion of the vertical part 132 toward the loading direction of the CD 5. Herein, the vertical part 132 serves to allow only a single CD to be loaded into the gate. The inclined part 131 serves to allow CDs to be smoothly unloaded or ejected when the CDs are forcefully loaded into the gate 2.

Heretofore, the guide unit 100 disposed on one side of the gate 2 has been described. Meanwhile, the guide unit 100′ disposed on the other side of the gate 2 has the same construction as the guide unit 100, so the detailed description thereof will be omitted. For example, in the guide unit 100′ disposed on the other side of the gate 2, the housing 110′ and the second axle 161′ are also installed.

The operation of the above-described CD deck apparatus according to a preferred embodiment of the present invention will be described.

Referring to FIGS. 1 and 3, the vertical part 132 of the guide piece 130 is disposed in the gate 2 so as to face the direction in which the CD is loaded to restrict the loading space of the gate 2. Thus, the vertical part 132 allows only one CD to pass through the gate 2. Herein, the turning plate 120 is engaged with the engaging rib 140 so that it does not rotate in the direction in which the CD is loaded.

When two CDs are forcefully loaded into the gate 2, it is difficult to unload or eject the CDs in the CD deck body outside. To solve this problem, as shown in FIG. 4, the guide piece 130 is provided with the inclined part 131 inclined downward in the loading direction of the CD and inclined upward in the unloading direction of the CD. Thus, when the inclined part 131 is rotated by the turning plate 120, ejecting space of the gate 2 is enlarged. The CDs forcefully loaded into the gate 2 can be easily ejected through the enlarged ejecting space of the gate 2.

Herein, when the elastic member 150 stretches due to the rotation of the turning plate 120, upon completion of the unloading of the CD, it returns to its original position together with the turning plate 120.

Although an embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A compact disk (CD) deck apparatus for vehicles comprising:
a CD deck body having a gate through which a CD is to be loaded and unloaded; and
a guide unit for guiding the loading and unloading of the CD, which includes a housing provided on the gate, a turning plate provided in the housing so as to rotate in an unloading direction of the CD, and a guide piece protruding from the turning plate such that one CD is loaded into the gate.

2. The CD deck apparatus for vehicles according to claim 1, wherein the guide piece has a vertical part disposed so as to face a loading direction of the CD, and an inclined part extending downward from an upper portion of the vertical part toward the loading direction of the CD.

3. The CD deck apparatus for vehicles according to claim 2, wherein an engaging rib is fixedly provided in the housing so as to prevent the turning plate from rotating in the loading direction of the CD.

4. The CD deck apparatus for vehicles according to claim 3, wherein the engaging rib is connected with the turning plate by an elastic member.
